(19) United States
(12) Patent Application Publication
(10) Pub. No.: US 2005/0272409 A1
(43) Pub. Date: Dec. 8, 2005

(54) Method and computer product for delivering mail-information and reception device

(75) Inventors: Atsumasa Mizuno, Kawasaki (JP); Osamu Ikegaki, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/092,746

(22) Filed: Mar. 30, 2005

(30) Foreign Application Priority Data
Jun. 4, 2004 (JP) 2004-167622

(51) Int. Cl. H04M 11/10

(52) U.S. Cl. 455/413

(57) ABSTRACT

A reception device issues a request for delivering mail information containing identification information for a broadcast station broadcasting a program that is currently watched to a mail-information delivery device. The mail-information delivery device acquires identification information for the program that is broadcast by the broadcast station, sorts mail information so that mails containing identification information for the program and identification information for the broadcast station are displayed on a higher rank, and returns a response to the reception device.

### BACKGROUND OF THE INVENTION

1) Field of the Invention

The present invention relates to a method and a computer product for delivering mail-information and a reception device for delivering electronic mail information to a subscriber via a network, and more particularly, to a method and a computer product for delivering mail-information and a reception device for preferentially displaying electronic mail information sent from a broadcast station or a broadcast program being watched by a viewer when delivering an electronic mail as an interactive service in digital broadcasting.

2) Description of the Related Art

Recently, the use of the Internet spreads rapidly, and a variety of usage patterns of electronic mail that is one of the Internet services increases accordingly. Conventionally, in almost all cases, personal computers (PCs) and work stations are used to send electronic mail, but at present, cellular phones are generally used to transmit and receive electronic mail.

It is a television that a network support is most advanced in home electric appliances. A type of television including an electronic mail function is widely spreading instead of a type in which electronic mail is transmitted and received through a home-use game machine or the like that has conventionally been available. For example, in Japanese Patent Application Laid-Open No. 2003-316699, a system is disclosed, in which electronic mail information is broadcast over an electric wave of digital broadcasting, a mail targeted for a viewer is selected by a reception device, and arrival of the mail is notified using a predetermined method corresponding to the degree of importance of the mail.

However, the above conventional technology does not control electronic mail and a broadcast program or a broadcast station based on mutual correlation between the electronic mail and the broadcast program or the broadcast station. Therefore, even if a viewer receives important electronic mail related to a broadcast station or its broadcast program which the viewer is currently watching, it is quite possible that he or she fails to recognize the electronic mail if a number of other mails are received.

### SUMMARY OF THE INVENTION

It is an object of the present invention to solve at least the above problems in the conventional technology.

A computer-readable recording medium according to one aspect of the present invention stores a mail-information delivery program for delivering electronic mail information to a subscriber via a network. The mail-information delivery program makes a computer execute receiving a request for delivering electronic mail information including at least identification information for a broadcast station in which the subscriber is currently tuning; and a mail information editing including identifying electronic mail information transmitted to the subscriber from the broadcast station, based on the identification information for the broadcast station, and displaying the electronic mail information identified with an utmost priority.

A mail-information delivery device according to another aspect of the present invention, which delivers electronic mail information to a subscriber via a network, includes a communication controller that receives a request for delivering electronic mail information including at least identification information for a broadcast station in which the subscriber is currently tuning; and a mail information editor that identifies electronic mail information transmitted to the subscriber from the broadcast station, based on the identification information for the broadcast station, and displays the electronic mail information identified with an utmost priority.

A mail-information delivery method according to still another aspect of the present invention, which is for delivering electronic mail information to a subscriber via a network, includes receiving a request for delivering electronic mail information including at least identification information for a broadcast station in which the subscriber is currently tuning; and a mail information editing including identifying electronic mail information transmitted to the subscriber from the broadcast station, based on the identification information for the broadcast station, and displaying the electronic mail information identified with an utmost priority.

A reception device according to still another aspect of the present invention, which receives a broadcast program, includes a communication controller that transmits a request for delivering electronic mail information transmitted to a user of the reception device, and receives the electronic mail information transmitted in response to the request; and a mail information editor that acquires identification information for a broadcast station from which the reception device currently receives a broadcast program, identifies electronic mail information transmitted to the user from the broadcast station based on the identification information acquired, and displays the electronic mail information identified with an utmost priority.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a schematic for explaining a system for an interactive service via a network;

FIG. 2 is a schematic for explaining how to refer to a mail on a digital television;

FIG. 3 is a block diagram of a system configuration of a mail display system according to a first embodiment of the present invention;

FIG. 4 is a table of an example of a mail list screen;

FIG. 5 is a flowchart of a process procedure for a reception device and a mail-information delivery device shown in FIG. 3;

FIG. 6 is a flowchart of a process procedure for sorting header information shown in FIG. 5;

FIG. 7 is a block diagram of a system configuration of a mail display system according to a second embodiment of the present invention; and

FIG. 8 is a flowchart of a process procedure for a reception device shown in FIG. 7.

### DETAILED DESCRIPTION

Exemplary embodiments of the present invention are explained in detail below with reference to the accompanying drawings.

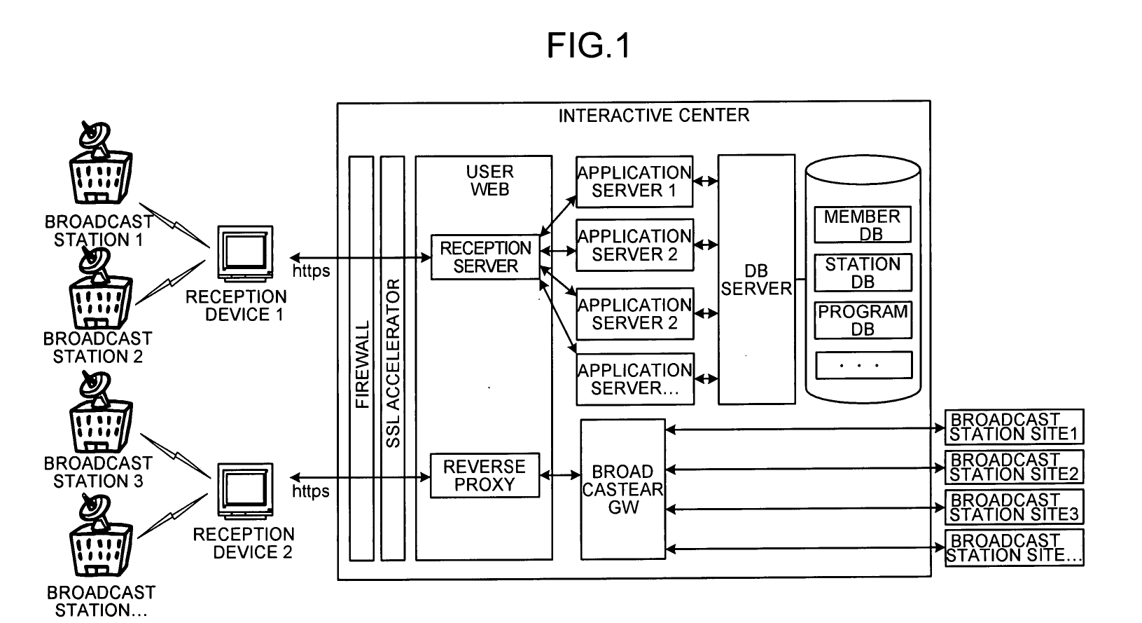

FIG. 1 is a schematic for explaining a system for an interactive service via a network. A reception device receives airwaves from a broadcast station and is connected through the Internet to an interactive center that is an interactive service provider. The interactive center is an agency that signs a contract with at least one of the broadcast stations and acts for provision of interactive services.

The interactive center includes a firewall for preventing illegal access, and a service sockets layer (SSL) accelerator for performing encryption/multiplexing of communication data at high speed, which are used to connect between the reception device and a WEB server of the interactive center. The WEB server includes an acceptance server and a reverse proxy, and is broadly classified into two types. One is connected to an application server in the interactive center to execute a service in the interactive center to provide information. Other relays a service executed in a broadcast station site through a gateway. The interactive center further includes a database (DB) server that includes a member DB, a station DB, and a program DB or the like, and a broadcaster GW. However, a difference of these services executed is not recognized from the side of the reception device.

There has been a system that provides interactive services based on on-line connection between a receiver and the interactive center, but the system is operated based on the connection using X.28 protocol at low speed. Therefore, services that can be provided are limited. However, the connection between the receiver and the interactive center through the Internet allows high speed connection using an asymmetric digital subscriber line (ADSL) or an optical fiber, which makes it possible to provide attractive services by making effective use of video images and the like with high responsivity.

For example, a weather forecast is broadcast only at a particular fixed time in TV broadcasting, and therefore, information cannot be obtained at once when it is necessary. Furthermore, in data broadcasting in the digital broadcasting, the weather forecast is broadcast all the time, but the same contents for all the viewers are broadcast. In this case also, information cannot be obtained at once when it is necessary.

On the other hand, in the interactive services provided from the interactive center, a viewer can specify information that the viewer desires, and obtain the information at any time in the same manner as WEB browsing, which makes it possible to obtain required information at once. If a viewer's device is connected to the interactive center with a high-speed line, even such large image data as a satellite photograph can be instantaneously displayed.

The viewer uses the system of the interactive services over the Internet in the above manner, which allows extraction of high quality information while communicating with the reception device without being conscious of the amount of information.

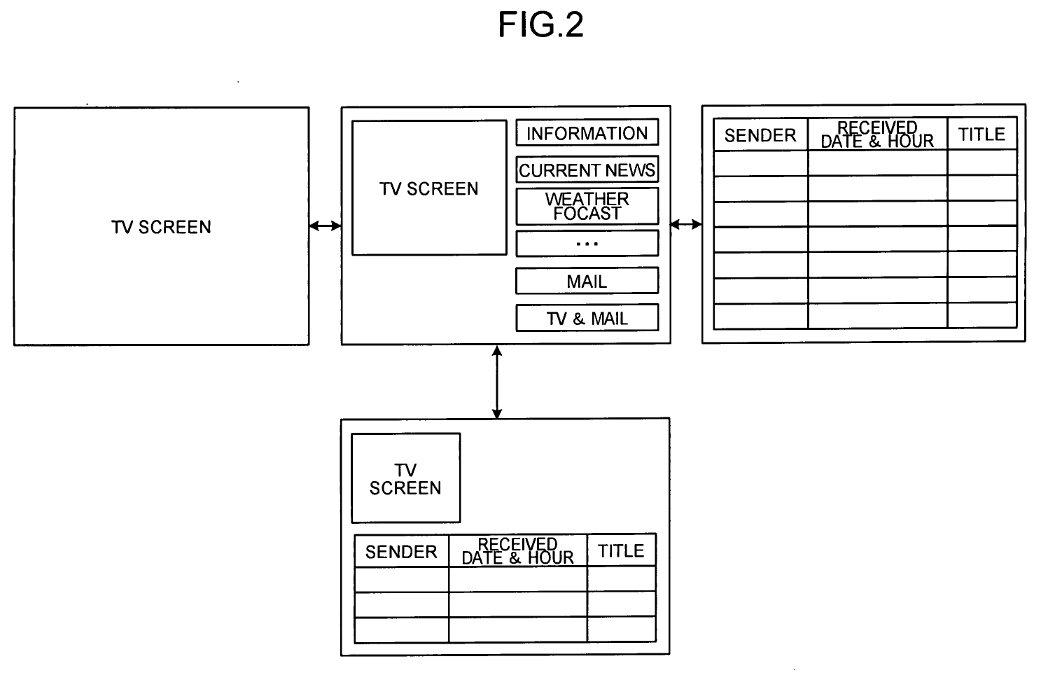

By using the system, digital broadcasting can offer the mail service. FIG. 2 is a schematic for explaining how to refer to a mail on a digital television. The digital television can split a screen to simultaneously display sub-screens for TV broadcasting and for data broadcasting or interactive service; thus, the digital television is suitable for using interactive services.

As shown in FIG. 2, when a screen for TV broadcasting is displayed, the viewer operates a remote controller to call up a Menu screen. The screen is then split to display selectable data broadcasting programs and interactive services in a part of the screens split. If an item displayed as “Mail” is selected, the reception device connects the interactive center through the Internet, and acquires a list of mails for the viewer to display the list on the screen. By using the function of splitting the screen of the digital television, the TV broadcasting and the list of mails for the viewer can also be simultaneously displayed. If one mail is selected from the list here, the reception device connects again the interactive center through the Internet, acquires the mail, and displays the contents of the mail on the screen.

In the digital broadcasting, the viewer can easily refer to a mail for himself/herself by using the interactive services in the above manner. The mail to be received includes a mail sent from a friend of him/her and information notification mail from a broadcast station or a broadcast program (hereinafter, “program”). Since a mail related to the broadcast station or the program that the viewer is watching at that time is preferentially displayed, the viewer can easily recognize the mail, which allows a higher possibility of making effective use of the mail.

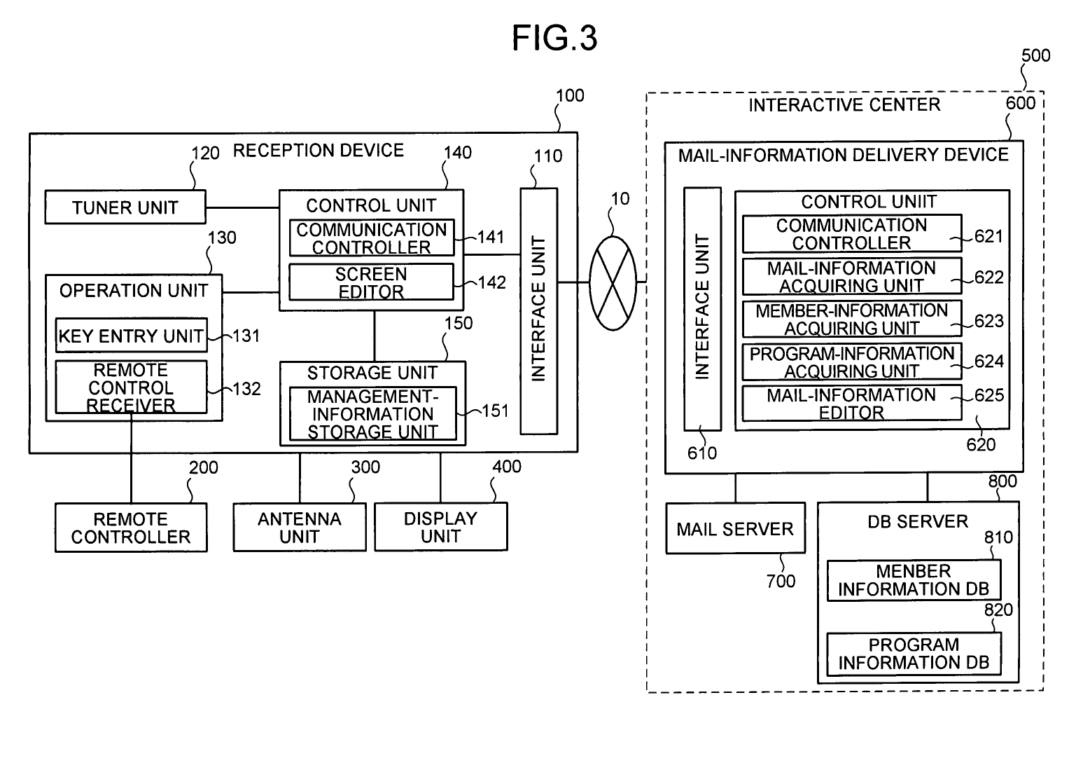

FIG. 3 is a block diagram of a system configuration of a mail display system according to a first embodiment of the present invention. The mail display system according to the first embodiment includes a reception device 100 and a mail-information delivery device 600, which are connected to each other through Internet 10.

The reception device 100 is used to receive digital broadcasting and the like at home, and is connected with an antenna unit 300 and a display unit 400 to receive a signal from a remote controller 200. The remote controller 200 is used to remotely operate the reception device 100, and receives an instruction from the viewer by depressing a button to transmit the signal to the reception device 100 using infrared ray or wirelessly. The antenna unit 300 is used to receive airwaves from a broadcast station.

The display unit 400 is used to display video images received from a broadcast station or information acquired from an interactive center 500, and is formed with, for example, a cathode-ray tube or a liquid crystal display unit. It is noted that the reception device 100 may be integrated with the display unit 400. Furthermore, the reception device 100 may be integrated with a recording player such as a videotape recording player and an optical disk recording player.

The reception device 100 includes an interface unit 110, a tuner unit 120, an operating unit 130, a control unit 140, and a storage unit 150. The interface unit 110 is a network interface used to connect to the Internet. The tuner unit 120 converts airwaves received by the antenna unit 300 to video signals.

The operating unit 130 is used to accept an operation from a viewer using the reception device 100, and includes a key entry unit 131 and a remote control receiver 132. The key entry unit 131 accepts an instruction from a viewer through a button or a dial provided in the reception device 100. The remote control receiver 132 receives a signal transmitted from the remote controller 200.

The control unit 140 controls the whole of the reception device 100, and includes a communication controller 141 and a screen editor 142.

The communication controller 141 controls the exchange of information with the mail-information delivery device 600 installed in the interactive center 500. More specifically, when receiving an instruction to acquire mail header information from the operating unit 130, the communication controller 141 acquires information to identify a viewer, from a management information storage unit 151. The communication controller 141 then transmits the information together with information used to identify a broadcast station carrying a program which the viewer is currently watching, to the mail-information delivery device 600, and requires for transmission of the mail header information. When requesting a display of the mail information, the viewer can select contents as to whether a mail related to the program being currently watched thereby is to be preferentially displayed. The content selected is embedded inside the request.

When receiving a response that includes the mail information from the mail-information delivery device 600, the communication controller 141 passes the response to the screen editor 142. The mail header information mentioned here indicates a title and a sender or the like of a mail.

When receiving an instruction to acquire the body of a mail from the operating unit 130, the communication controller 141 identifies which is a mail to be acquired, transmits the mail together with information used to identify a viewer to the mail-information delivery device 600, and requires for transmission of the body of the mail. The communication controller 141 acquires a response from the mail-information delivery device 600 and passes the response to the screen editor 142.

The screen editor 142 is a controller that converts the information acquired by the communication controller 141 to an image, transmits the image to the display unit 400, and causes the display unit 400 to display the image. More specifically, the communication controller 141 acquires the mail header information and the body of the mail from the mail-information delivery device 600, and the screen editor 142 converts them to images and transmits the images to the display unit 400.

The storage unit 150 includes the management information storage unit 151. The management information storage unit 151 stores contract information of a viewer who uses the receiver and information entered by the viewer.

The mail-information delivery device 600 is installed in the interactive center 500, and is connected to a mail server device 700 and a DB server device 800 through a Local Area Network (LAN) or the like. The mail server device 700 transmits and receives mails and saves the mails. For example, a server device including a simple mail transfer protocol (SMTP) service function corresponds to the mail server device 700.

The DB server device 800 manages various types of information, and includes a member information DB 810 and a program information DB 820. The member information DB 810 stores information related to viewers who have signed the use contract of the interactive services with the interactive center 500. The program information DB 820 stores broadcast time or the like for programs that are broadcast by a broadcast station of which interactive services are executed by the interactive center as a proxy. The information stored in the program information DB 820 is updated in real time with information transmitted from the broadcast station.

It is noted that either one or both of the mail server device 700 and the DB server device 800 may be integrated with the mail-information delivery device 600.

The mail-information delivery device 600 includes an interface unit 610 and a control unit 620. The interface unit 610 is a network interface for connecting with the Internet.

The control unit 620 controls the whole of the mail-information delivery device 600, and includes a communication controller 621, a mail information acquiring unit 622, a member information acquiring unit 623, a program-information acquiring unit 624, and a mail information editor 625.

The communication controller 621 controls the exchange of information with the reception device 100. More specifically, when receiving a request for transmission of mail header information, the communication controller 621 checks whether the information for a viewer contained in the request is appropriate. If it is appropriate, the communication controller 621 acquires the mail header information for the viewer, edits this information, and returns it as a response.

The editing mentioned here includes the process for preferential display of a mail related to the broadcast station contained in the request. If the request contains an instruction to display a mail, with top priority, related to a program that is currently being broadcast, identification information embedded inside the request is used to acquire the information for the, program that is broadcast by the broadcast station, from the program information DB 820, and displays the mail related to the program with top priority.

A correlation between the mail and the broadcast station or the program can be realized by, for example, embedding identification information for the broadcast station or the program inside the header of the mail. Furthermore, the correlation may be achieved by preparing a particular mailbox for each broadcast station or program.

When receiving a request for transmission of the body of a mail from the reception device 100, the communication controller 621 acquires the body of the mail and returns it as a response.

The mail information acquiring unit 622 is a processor that acquires mail header information or the body of a mail from the mail server device 700. The member information acquiring unit 623 is a processor that acquires information for members that use the interactive services, from the member information DB 810. The information for the members is used when the communication controller 621 determines whether a viewer who requests the mail information is an appropriate member. The program-information acquiring unit 624 is a processor that acquires information for a program that is broadcast by a broadcast station, from the program information DB 820, based on the identification information for the broadcast station and the current time as keys.

The mail information editor 625 is a processor that sorts header information of mails in a predetermined order and edits them in a list form. More specifically, sorting is carried out based on such priorities as, (1) unopened mail related to a program that the viewer is currently watching, (2) unopened mail related to a broadcast station carrying the program that the viewer is currently watching, (3) any other unopened mail, (4) opened mail related to the program that the viewer is currently watching, (5) opened mail related to the broadcast station carrying the program that the viewer is currently watching, and (6) any other opened mail. However, the priorities (1) and (4) become effective only when the viewer requests so.

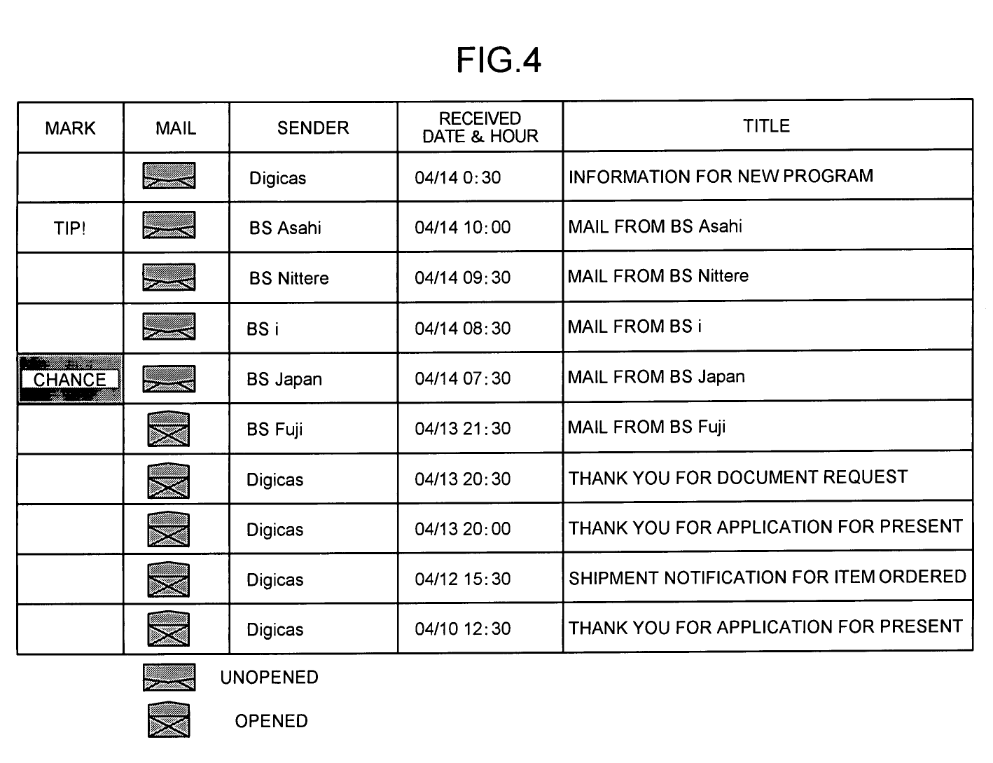

As a result of the sorting, a sample of a screen to be displayed on the reception device 100 is shown here. FIG. 4 is a table of an example of a mail list screen. This table represents a screen when the viewer allows a mail list to be displayed when watching a program from “Digicas” broadcast station.

As shown in FIG. 4, an unopened mail sent from the Digicas is displayed in the top line of the mail list, and unopened mails from other broadcast stations are displayed in several lines under the top line. Opened mails from the Digicas are further displayed in lower lines under the several lines. Some more opened mails from the other broadcast stations are displayed in lines under the lower lines of the list although they are not shown due to a limited display area of the screen. By preferentially displaying the mails related to the program or the broadcast station in the above manner, it becomes easy to refer to the mails, which allows a higher possibility of making effective use of the mails.

It is noted that the order of sorting is not necessarily in the above manner. For example, the sorting may be made without classifying the opened mails and unopened mails. Furthermore, the order of the sorting may be changed according to the request from a viewer. In the first embodiment, the method of preferentially displaying mails by displaying mail information for the program or for the broadcast station on a higher rank is used. However, a method of preferentially displaying mails by changing a color of a character or a background color of a character or the like may be used in combination or alone.

The mail information editor 625 also has a function of not displaying a mail unless it is a delivery time. Assume that a person in charge of a program wants to deliver mail together with the contents of the program in a certain time during broadcasting. In this case, if the time is specified and mail is transmitted, then the mail information editor 625 edits mail information while ignoring the mail until the time passes.

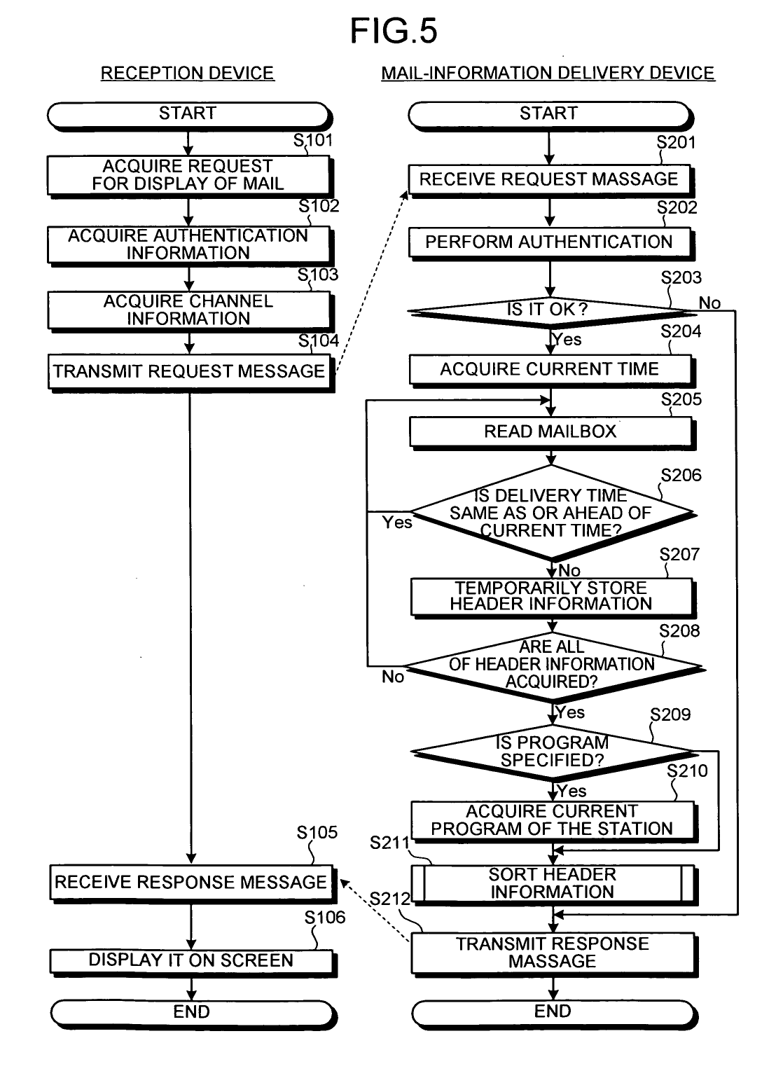

The process procedure for a mail display system according to the first embodiment is explained below. Here, the process procedure for causing the reception device to display header information of a mail is explained. The header information of the mail is a characteristic portion of the first embodiment. FIG. 5 is a flowchart of a process procedure for a reception device 100 and a mail-information delivery device 600 shown in FIG. 3.

As shown in FIG. 5, when receiving an instruction to display a mail through the operating unit 130 (step S101), the reception device 100 acquires identification information for a viewer from the management information storage unit 151 (step S102), further acquires identification information for a broadcast station carrying a program being currently watched (step S103), and transmits these pieces of information together with the information acquired through the operating unit 130, to the mail-information delivery device 600 (step S 104).

When receiving a request message from the reception device 100 (step S201), the mail-information delivery device 600 extracts the identification information for the viewer from the request message, acquires member information corresponding to the identification information from the member information DB 810, and checks whether the viewer is authorized as an appropriate user (step S202). If there is no corresponding information or if the viewer (requester) is not authorized as the appropriate user (step S203, No), then the mail-information delivery device 600 returns an error massage to a transmission source (step S212).

If the requester is authorized as the appropriate user (step S203, Yes), the mail-information delivery device 600 acquires the current time (step S204). Then, the mail-information delivery device 600 extracts one mail for the viewer from a mailbox (step S205), and compares the delivery time contained in the header information of the mail with the time acquired at step S204. If the delivery time is set ahead of the current time (step S206, Yes), then the mail-information delivery device 600 ignores the mail, returns to step S205, and acquires a next mail thereat.

If the delivery time is set prior to the current time (step S206, No), then the mail-information delivery device 600 temporarily stores the header information for the mail acquired (step S207). If all the mails for the viewer are not read in the above manner (step S208, No), the processes from step S205 to step S207 are executed again.

If all the mails for the viewer are read (step S208, Yes), then the mail-information delivery device 600 checks whether there is an instruction to give a priority to the program being watched in the request message. If there is the instruction (step S209, Yes), then the mail-information delivery device 600 acquires identification information for a program being currently broadcast by a broadcast station, from the program information DB 820 (step S210). More specifically, the identification information is acquired based on the identification information for the broadcast station contained in the request message and the current time acquired at step S204 as search keys.

The mail-information delivery device 600 sorts the mail information acquired based on the process procedure as explained later (step S211), and transmits the result of sorting to the reception device 100 as a request source (step S212).

When receiving a response from the mail-information delivery device 600 (step S105), the reception device 100 converts the response to an image in the screen editor 142 and displays the image on the display unit 400 (step S106). In such a manner as explained above, the mail related to the program or the broadcast station is displayed in a preferential manner on the display unit 400 connected to the reception device 100.

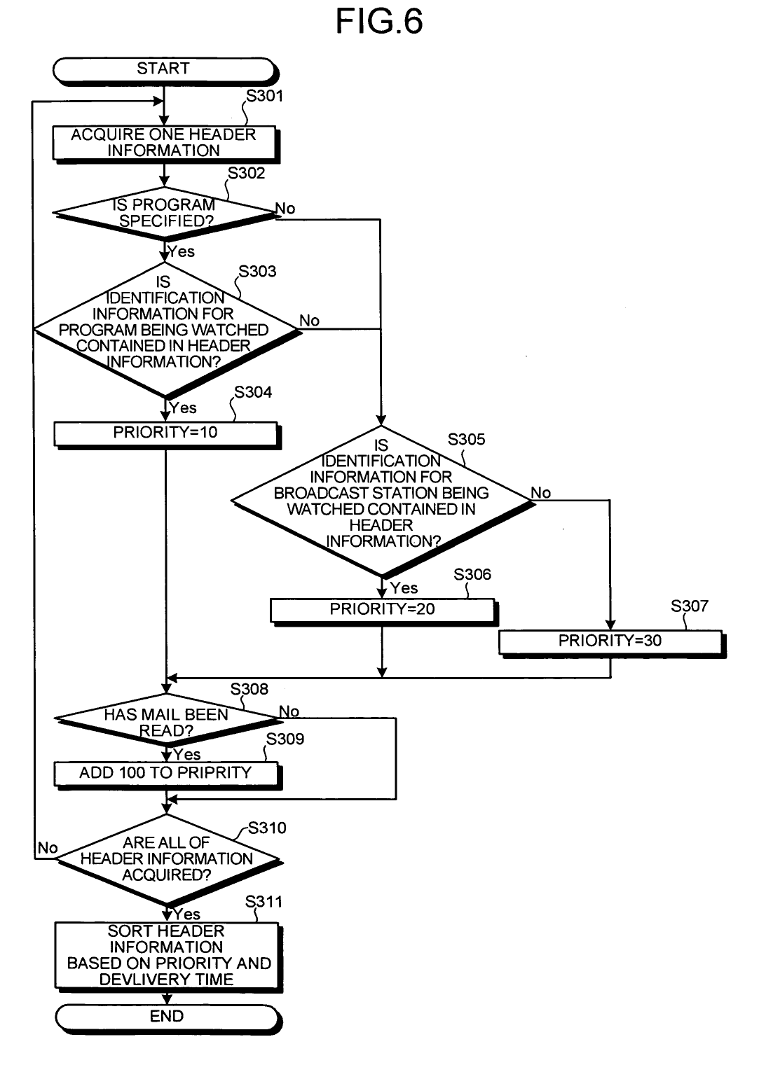

FIG. 6 is a flowchart of a process procedure for sorting header information shown in FIG. 5. As shown in FIG. 6, the mail-information delivery device 600 acquires one header information of the mail temporarily stored (step S301). If there is an instruction to give a priority to the program being watched in the request that is transmitted from the reception device 100 (step S302, Yes), and if the identification information for the program being watched is contained in the header information acquired (step S303, Yes), then the mail-information delivery device 600 gives a “10-th” priority to the mail header information (step S304).

If there is no instruction to give a priority to the program being watched in the request (step S302, No), or if the identification information for the program being watched is not contained in the header information acquired (step S303, No), then the mail-information delivery device 600 checks whether the identification information for a broadcast station carrying the program being watched is contained in the mail header information. If the identification information for the broadcast station is contained therein (step S305, Yes), then the mail-information delivery device 600 gives a “20-th” priority to the mail header information (step S306). If the identification information for the broadcast station is not contained therein (step S305, No), then the mail-information delivery device 600 gives a “30-th” priority to the mail header information (step S307).

The mail-information delivery device 600 checks whether the mail has been read after the priority is once given to the mail header information in the above manner. If the mail has been read (step S308, Yes), the mail-information delivery device 600 adds 100 to the priority of the mail header information (step S309). If the mail has not been read (step S308, No), the mail-information delivery device 600 uses the priority given as it is.

If all the header information for the mails temporarily stored are not acquired (step S310, No), the processes from step S301 to step S309 are executed again. If all the header information for the mails temporarily stored are acquired (step S310, Yes), the mail-information delivery device 600 sorts the header information for the mails acquired based on the priority and the delivery time (step S311).

In the first embodiment as explained above, the identification information for the broadcast station carrying the program being watched by the viewer is transmitted from the reception device 100 to the mail-information delivery device 600. Then, the mail-information delivery device 600 sorts the electronic mail information so that the electronic mail related to the identification information for the broadcast station is displayed on a higher rank. This allows preferential display of the electronic mail sent from the broadcast station carrying the program that the viewer is watching.

Furthermore, in the first embodiment, pieces of information for programs and their broadcast times are stored in the program information DB, and particular information for a program can be acquired. The program is broadcast by a broadcast station that corresponds to the identification information for the broadcast station transmitted from the reception device 100. Thus, the electronic mail sent from the program which the viewer is watching can be preferentially displayed.

According to the first embodiment, it is explained that the mail-information delivery device installed in the interactive center sorts the header information for mails to preferentially display a mail related to a program or a broadcast station. However, the process of sorting may also be executed in the reception device. In a second embodiment of the present invention, a case of executing the process of sorting in the reception device is explained.

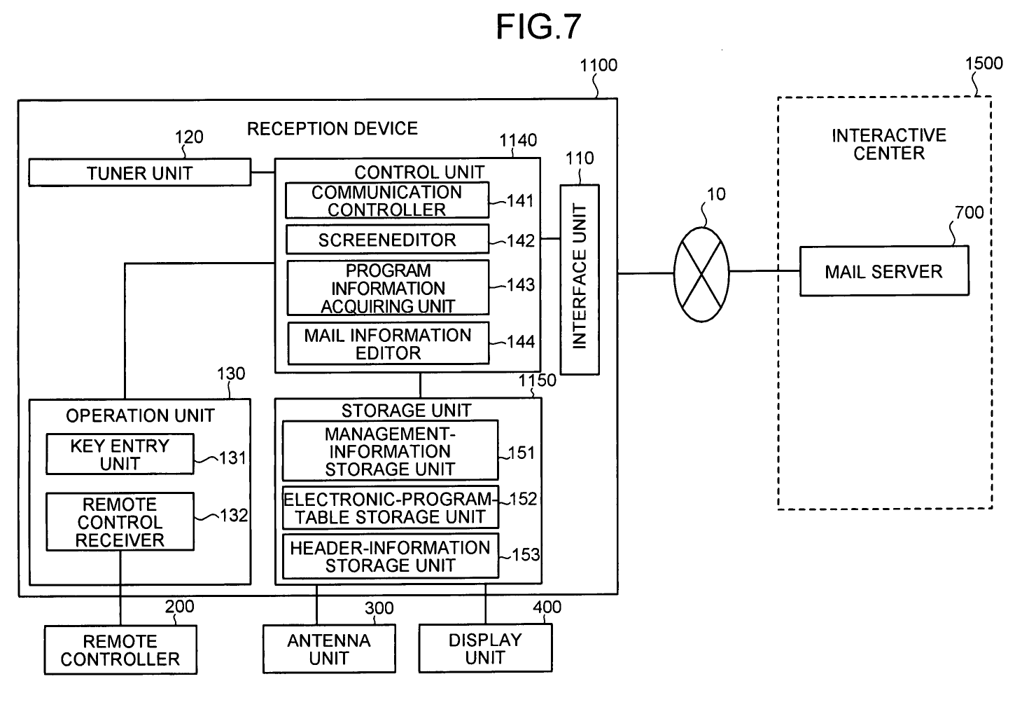

FIG. 7 is a block diagram of a system configuration of a mail display system according to the second embodiment. The mail display system according to the second embodiment includes a reception device 1100 and the mail server device 700, which are connected to each other through the Internet 10.

The mail server device 700 is installed in an interactive center 1500, and transmits and receives mails and saves the mails. For example, a server device including the SMTP service function corresponds to the mail server device 700. Mail information is exchanged between the mail server device 700 and the reception device 1100 using communication protocol such as internet message access protocol (IMAP) and post office protocol (POP).

Regarding the reception device 1100, only a difference from the first embodiment is explained below. A control unit 1140 includes the communication controller 141 and the screen editor 142, and further includes a program-information acquiring unit 143 and a mail information editor 144.

According to the second embodiment, the communication controller 141 controls the exchange of information with the mail server device 700 installed in the interactive center 1500. More specifically, when receiving an instruction to acquire mail header information from the operating unit 130, the communication controller 141 acquires authentication information corresponding to a viewer from the management information storage unit 151 of a storage unit 1150, and transmits the authentication information to the mail server device 700 to request transmission of mail header information.

The program-information acquiring unit 143 is a processor that acquires program information such as a broadcast time or the like of a program to be broadcast by a broadcast station, and stores the program information in an electronic-program-table storage unit 152. The broadcast station transmits program table information called electronic program guide (EPG) contained in a part of the airwaves over which a program is broadcast. The program-information acquiring unit 143 acquires program information from the EPG. However, the program-information acquiring unit 143 may acquire program information over the Internet 10.

The mail information editor 144 is a processor that sorts header information of mails in a predetermined order and edits them in a list form. More specifically, the sorting is carried out based on such priorities as, (1) unopened mail related to a program that the viewer is currently watching, (2) unopened mail related to a broadcast station carrying the program that the viewer is currently watching, (3) any other unopened mail, (4) opened mail related to the program that the viewer is currently watching, (5) opened mail related to the broadcast station carrying the program that the viewer is currently watching, and (6) any other opened mail. However, the priority of (1) and (4) becomes effective only when the viewer requests so.

The order of sorting does not need to be carried out as it is, and may be carried out without distinguishing between opened mails and unopened mails. Alternatively, it may be configured to change the order of sorting according to the request from a viewer. In the second embodiment, the method of preferentially displaying mails by displaying mail information for the program or for the broadcast station on a higher rank is used. However, a method of preferentially displaying mails by changing a color of a character or a background color of a character or the like may be used in combination or alone.

The storage unit 150 includes the electronic-program-table storage unit 152 and a header information storage unit 153 in addition to the management information storage unit 151. The electronic-program-table storage unit 152 stores program information acquired by the program-information acquiring unit 143.

The header information storage unit 153 stores header information of mails acquired by the communication controller 141. The header information of the mails acquired by the communication controller 141 is stored therein until new information is acquired, read by the mail information editor 144 according to the instruction from the operating unit 130 at an arbitrary time, and displayed on the display unit 400.

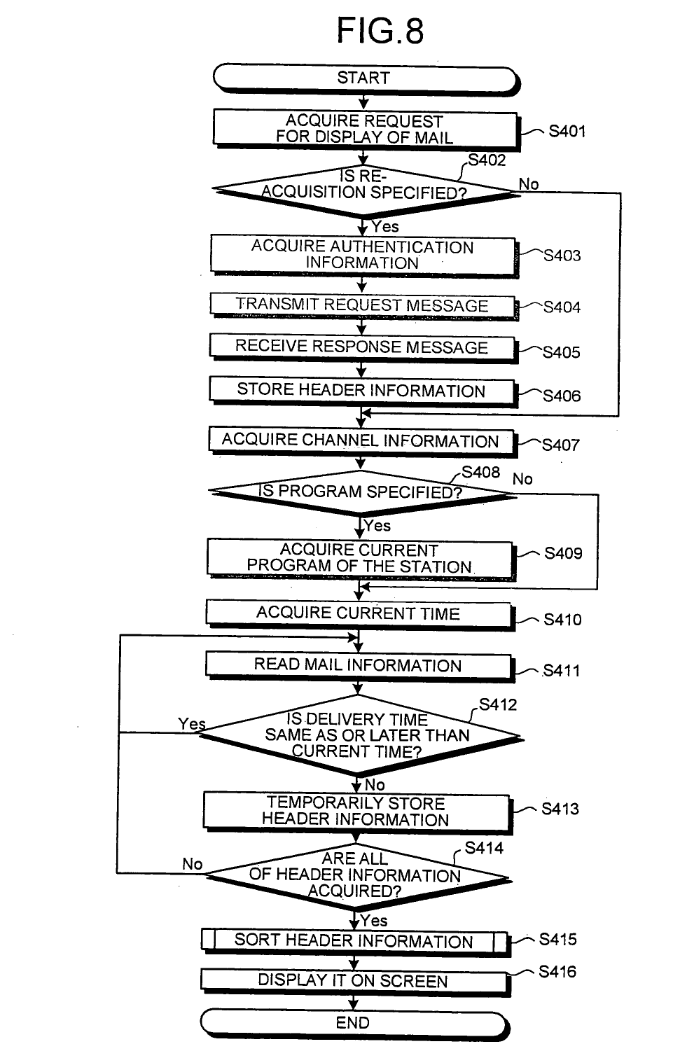

The process procedure for a mail display system according to the second embodiment is explained below. Here, the process procedure for causing the reception device to display header information of a mail is explained. The header information of the mail is a characteristic portion of the second embodiment. FIG. 8 is a flowchart of a process procedure for a reception device 1100 shown in FIG. 7.

As shown in FIG. 8, when receiving an instruction to display a mail through the operation unit 130 (step S401), the reception device 1100 checks whether another instruction to re-acquire header information of the mail from the mail server device 700 is contained in the instruction. If it is not contained in the instruction (step S402, No), then the reception device 1100 starts the process from step S407 without performing communication with the mail server device 700.

If the another instruction is contained in the instruction (step S402, Yes), the reception device 1100 acquires authentication information for a viewer from the management information storage unit 151 (step S403), and transmits the authentication information to the mail server device 700 to request header information of the mail (step S404). When receiving a response from the mail server device 700 (step S405), the reception device 1100 stores the response in the header information storage unit 153 (step S406).

The reception device 1100 acquires identification information for a broadcast station carrying the program that is currently watched (step S407), and checks whether another instruction to give a priority to the program being watched is contained in the instruction through the operating unit 130. If there is the another instruction therein (step S408, Yes), the reception device 1100 acquires identification information for the program being broadcast by the broadcast station and being currently watched, from the electronic-program-table storage unit 152 (step S409).

The reception device 1100 acquires the current time (step S410). Then, the reception device 1100 extracts one mail for the viewer from the header information storage unit 153 (step S411), and compares a delivery time contained in the header information of the mail with the current time. If the delivery time is set ahead of the current time (step S412, Yes), then the reception device 1100 ignores the mail, returns to step S410, and acquires a next mail thereat.

If the delivery time is set prior to the current time (step S412, No), then the reception device 1100 temporarily stores the header information for the mail acquired (step S413). If all the mails for the viewer are not read in the above manner (step S414, No), the processes from step S411 to step S413 are executed again.

If all the mails for the viewer are read (step S414, Yes), then the reception device 1100 sorts the mail information acquired based on the process procedure of FIG. 6 (step S415), converts the mail information sorted to an image in the screen editor 142, and displays the image on the display unit 400 (step S416). The mail related to the program or the broadcast station is displayed in a preferential manner on the display unit 400 connected to the reception device 1100.

According to the second embodiment, as explained above, the reception device 1100 identifies the broadcast station and the program being currently watched by a viewer, and sorts electronic mail information so that electronic mails related to the program and the broadcast station are listed in a higher rank. Thus, the electronic mails from the broadcast station and the program that the viewer is currently watching can be preferentially displayed on the display unit.

According to one aspect of the present invention, identification information for a broadcast station carrying a program being watched by a viewer is acquired, and an electronic mail sent from the broadcast station is preferentially displayed based on the identification information. Therefore, the electronic mail transmitted from the broadcast station carrying the program being watched by the viewer is easily found by the viewer, which makes it possible to enhance the possibility of making effective use of the electronic mail.

According to another aspect of the present invention, another identification information for a program being watched by a viewer is further acquired, and an electronic mail sent from the program or the broadcast station is preferentially displayed based on the identification information for the broadcast station and the another identification information for the program. Therefore, the electronic mail transmitted from the broadcast station or the program being watched by the viewer is easily found by the viewer, which makes it possible to enhance the possibility of making effective use of the electronic mail.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

1. A computer-readable recording medium that stores a mail-information delivery program for delivering electronic mail information to a subscriber via a network, wherein the mail-information delivery program makes a computer execute
receiving a request for delivering electronic mail information including at least identification information for a broadcast station in which the subscriber is currently tuning; and
a mail information editing including
identifying electronic mail information transmitted to the subscriber from the broadcast station, based on the identification information for the broadcast station; and
displaying the electronic mail information identified with an utmost priority.

2. The computer-readable recording medium according to claim 1, wherein
the mail-information delivery program further makes the computer execute acquiring identification information for a broadcast program that the broadcast station is currently broadcasting, and
the mail information editing further includes
identifying first electronic mail information transmitted to the subscriber from a broadcast program that the subscriber is currently watching and second electronic mail information transmitted to the subscriber from the broadcast station, based on the identification information for the broadcast program and the identification information for the broadcast station; and
displaying the first electronic mail information with a first priority and the second electronic mail information with a second priority.

3. The computer-readable recording medium according to claim 1, wherein the mail information editing further includes sorting the electronic mail information so that electronic mail information with a higher priority is displayed on a higher rank.

4. A mail-information delivery device that delivers electronic mail information to a subscriber via a network, the mail-information delivery device comprising:
a communication controller that receives a request for delivering electronic mail information including at least identification information for a broadcast station in which the subscriber is currently tuning; and
a mail information editor that identifies electronic mail information transmitted to the subscriber from the broadcast station, based on the identification information for the broadcast station, and displays the electronic mail information identified with an utmost priority.

5. A mail-information delivery method of delivering electronic mail information to a subscriber via a network, the mail-information delivery method comprising:
receiving a request for delivering electronic mail information including at least identification information for a broadcast station in which the subscriber is currently tuning; and
a mail information editing including
identifying electronic mail information transmitted to the subscriber from the broadcast station, based on the identification information for the broadcast station; and
displaying the electronic mail information identified with an utmost priority.

6. A reception device that receives a broadcast program, the reception device comprising:
a communication controller that transmits a request for delivering electronic mail information transmitted to a user of the reception device, and receives the electronic mail information transmitted in response to the request; and
a mail information editor that acquires identification information for a broadcast station from which the reception device currently receives a broadcast program, identifies electronic mail information transmitted to the user from the broadcast station based on the identification information acquired, and displays the electronic mail information identified with an utmost priority.

7. The reception device according to claim 6, further comprising a program-information acquiring unit that acquires identification information for a broadcast program that is currently broadcast by a broadcast station in which the user is currently tuning, wherein
the mail information editor identifies first electronic mail information transmitted to the subscriber from a broadcast program that the subscriber is currently watching and second electronic mail information transmitted to the subscriber from the broadcast station, based on the identification information for the broadcast program and the identification information for the broadcast station, and displays the first electronic mail information with a first priority and the second electronic mail information with a second priority.

8. The reception device according to claim 6, further comprising a storage unit that stores the electronic mail information received by the communication controller, wherein
the mail information editor identifies, when displaying the electronic mail information stored in the storage unit, electronic mail information transmitted to the user from the broadcast station based on the identification information for the broadcast station, and displays the electronic mail information identified with the utmost priority.

9. The reception device according to claim 8, wherein the mail information editor identifies, when displaying the electronic mail information stored in the storage unit, first electronic mail information transmitted to the subscriber from a broadcast program that the subscriber is currently watching and second electronic mail information transmitted to the subscriber from the broadcast station, based on the identification information for the broadcast program and the identification information for the broadcast station, and displays the first electronic mail information with a first priority and the second electronic mail information with a second priority.

10. The reception device according to claim 6, wherein the mail information editor sorts the electronic mail information so that electronic mail information with a higher priority is displayed on a higher rank.
